(19) United States
(12) Patent Application Publication
(10) Pub. No.: US 2009/0278983 A1
(43) Pub. Date: Nov. 12, 2009

(54) DIGITAL VIDEO SIGNAL TRANSMITTER AND RECEIVER AND INCLUDING SYSTEM

(75) Inventors: Machiko AZUMA, Saitama (JP); Yuko EGUCHI, Tokyo (JP)

Correspondence Address: DITTHAVONG MORI & STEINER, P.C., 918 Prince St., Alexandria, VA, 22314, US

(73) Assignee: HOYA CORPORATION, Tokyo (JP)

(21) Appl. No.: 12/432,914

(22) Filed: Apr. 30, 2009

(30) Foreign Application Priority Data
May 8, 2008 (JP) 2008-121887

(51) Int. Cl. H04N 5/04

(52) U.S. Cl. 348/521; 348/E05.009

(57) ABSTRACT

A digital video signal transmitter is provided that comprises a digital video supplier, a synchronization signal generator, and a signal generator. The digital video supplier supplies a digital video signal including effective pixel signals comprised of pixel data from an effective pixels area and blanking signals comprised of data from a blanking area. The synchronization signal generator outputs a synchronization signal which is synchronized with the digital video signal. The signal generator generates a compound video signal in which a plurality of synchronization-indication signals that indicate the timing of the synchronization signal is incorporated into the blanking signals with respect to the digital video signal and the synchronization signal.

### BACKGROUND OF THE INVENTION

1. Field of the Invention

The present invention relates to a transmitter and a receiver that may be applied in an electronic endoscope system or the like, to transmit digital video signals, and a system including the above transmitter and receiver.

2. Description of the Related Art

Generally, an electronic endoscope system includes a scope provided with an imaging sensor and a signal-processing apparatus that performs image signal processing on video signals which are generated by the imaging sensor. Furthermore, in recent years, an electronic endoscope system of a type that transmits the video signals in digital format is provided. In this system, the video signals from the imaging sensor of the scope are digitized and then transmitted as parallel or serial data, through transmission lines including an electrical wire, to an image-processing circuit provided inside the signal-processing apparatus (see Kokai 2005-185305).

When transmitting the digital video signals, data representing a horizontal synchronization signal and a vertical synchronization signal are composited with the digital video signals during a horizontal blanking period and a vertical blanking period, to synchronize an image (see Kokai 2004-305373).

### SUMMARY OF THE INVENTION

As described in Kokai 2004-305373, the data representing the synchronization signals (the horizontal and vertical synchronization signals) are composited with the digital video signals during the digital video signal transmission, and thus images of the receiver's side are synchronized with the transmitter's side. However, when the data representing the synchronization signals is corrupted by external noise or the like, the synchronization of images between the transmitter and the receiver becomes disordered, and the reproduction of normal images on the receiver's side can not be performed.

Therefore, an object of the present invention is to provide a digital video signal transmitter and receiver that enable reproduction of an acceptable image even when the synchronization signal of a digital video signal is corrupted by noise during transmission.

Another object of the present invention is to provide a digital video signal transmission system including the above transmitter and receiver.

A further object of the present invention is to provide a method for transmitting a digital video signal that shows improved robustness to signal deterioration during transmission.

According to the first aspect of the present invention, a digital video signal transmitter is provided that comprises a digital video supplier, a synchronization signal generator, and a signal generator. The digital video supplier supplies a digital video signal including effective pixel signals comprised of pixel data from an effective pixel area on an imaging sensor, and blanking signals comprised of data from a blanking area of that imaging sensor. The synchronization signal generator outputs a synchronization signal which is synchronized with the digital video signal. The signal generator generates a compound video signal in which a plurality of synchronization-indication signals indicating that the timing of the synchronization signal is incorporated into the blanking signals with reference to the digital video signal and the synchronization signal.

The synchronization-indication signals may correspond to pixels from a leading pixel that is at least two pixels preceding the effective pixel area, to a final pixel of the blanking area, and each pixel datum corresponding to the synchronization-indication signals may comprise data representing the positional relationship between each of the respective pixels and the final pixel. The pixel data corresponding to the synchronization-indication signals may decrement from the leading pixel to the final pixel, in order. Furthermore, pixel data related to the synchronization signal may be binary data comprised of a plurality of bits, and a synchronization-indication signal corresponding to the final pixel may be binary data in which the least significant bit is 0. As a result, it is possible to transmit a digital video signal in which the synchronization signal can be detected using simple structure.

The digital video signal transmitter may further comprise a delay circuit that delays the digital video signal by a period corresponding to a predetermined number of pixels with respect to the synchronization signal, and the signal generator may incorporate the synchronization-indication signals into the predetermined pixels. Consequently, it becomes possible to transmit a digital video signal in which the synchronization signal may be reliably detected.

The synchronization signal may include a horizontal synchronization signal and a vertical synchronization signal, while a synchronization-indication signal for the horizontal synchronization signal and a synchronization indication signal for the vertical synchronization signal may remain separate signals. As a result, the horizontal synchronization signal and the vertical synchronization signal may be detected separately.

The digital video transmitter may further comprise an encoder that generates a composite code signal by encoding the compound video signal into DC-free code, and a serializer that serializes the composite code signal and transmits a serialized composite code signal. Thus, noise is suppressed and the number of channels can be reduced.

The signal generator may generate a synchronization pulse in accordance with the synchronization signal and generate a blanking pulse within a period of the blanking signals, and the encoder may encode the synchronization pulse and the blanking pulse into DC-free code and composites including the composite code signal. As an example, the DC-free code may comprise 8B/10B code. As a result, detection of the synchronization signal is straightforward.

According to the second aspect of the present invention, a digital video signal receiver for receiving the digital video signal is provided. The digital video signal receiver comprises a receiver, an indication signal detector, a synchronization-indication prediction signal generator, a synchronization signal generator, and a coincidence counter.

The receiver receives the compound video signal in which the plurality of synchronization-indication signals indicating that the timing of a synchronization signal has been incorporated into the blanking signals with reference to the digital video signal and the synchronization signal. The indication signal detector detects the synchronization-indication signal from the compound video signal. The synchronization-indication prediction signal generator generates a synchronization-indication prediction signal by predicting a succeeding synchronization-indication signal from a first synchronization-indication signal detected by the indication signal detector. The synchronization signal generator reproduces the synchronization signal in accordance with the synchronization-indication prediction signal. The coincidence counter counts the number of coincidences between the synchronization-indication prediction signal and the synchronization-indication signal. In addition, the synchronization signal is output from the synchronizing generator when the number of coincidences is two or greater.

The compound video signal may be encoded into a serial composite code signal composed of DC-free code, and the digital video signal receiver further comprises a serial/parallel converter that receives the serial composite code signal and converts the serial data of the serial composite code signal into parallel data, and a decoder that reproduces the compound video signal by decoding the parallel data of the composite code signal received by the serial/parallel converter. As a result, noise is suppressed and the number of channels can be reduced.

According to the third aspect of the present invention, a digital video transmission system is provided that comprises the digital video signal transmitter and the digital video signal receiver.

The digital video transmitter may further comprise an encoder that generates a composite code signal by encoding the compound video signal into DC-free code, and a serializer that serializes the composite code signal and transmits the result. When these components are present, the digital video signal receiver further comprises a serial/parallel converter that receives the serialized composite code signal and converts that serial data into parallel data, and a decoder that reproduces the compound video signal by decoding the serialized composite code signal received by said serial/parallel converter. Noise is thereby suppressed and the number of channels can be reduced.

According to the fourth aspect of the present invention, a method for transmitting a digital video signal is provided. The method comprises outputting a digital video signal including effective pixel signals comprised of pixel data from an effective pixel area and blanking signals comprised of data from a blanking area; outputting a synchronization signal which is synchronized to the digital video signal; and generating a compound video signal in which a plurality of synchronization-indication signals that indicate the timing of the synchronization signal is incorporated into the blanking signals with reference to the digital video signal and the synchronization signal.

### BRIEF DESCRIPTION OF THE DRAWINGS

The objects and advantages of the present invention will be better understood from the following description, with reference to the accompanying drawings in which:

FIG. 1 is a block diagram of an electronic endoscope system including a digital video signal transmitter and receiver;

FIG. 2 is a diagram illustrating the relationship between pixels in a CMOS, a clock pulse, a vertical synchronization signal, and a horizontal synchronization signal;

FIG. 3 is a block diagram showing the structure of an 8B/10B converter;

FIG. 4 is a timing chart for illustrating functions of the 8B/10B converter shown in FIG. 3;

FIG. 5 is an example of the encoding table applied in the 8B/10B converter; and

FIG. 6 is a block diagram showing the structure of a 10B/8B converter.

### DESCRIPTION OF THE PREFERRED EMBODIMENTS

The present invention is described below with reference to the embodiments shown in the drawings.

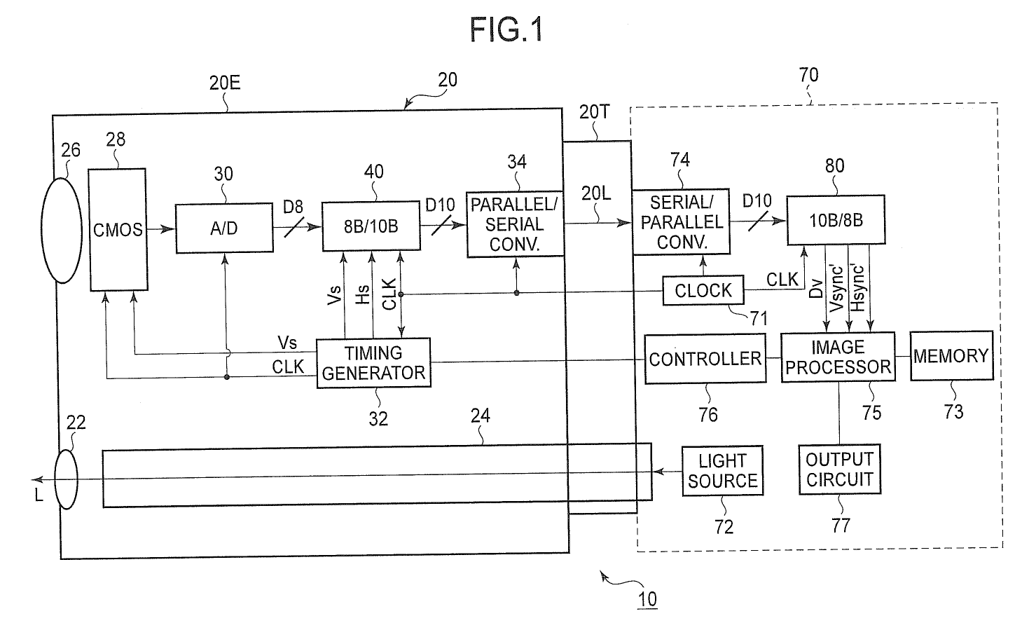

FIG. 1 shows a block diagram of an electronic endoscope system that includes the digital video signal transmitter and receiver of the present embodiment.

The electronic endoscope system 10 includes a scope 20 and a signal-processing apparatus 70. The scope 20 includes an insertion portion, which is inserted into a human body, and a universal cord 20T. The distal end of the insertion portion, i.e., a scope tip portion 20E, and the signal-processing apparatus 70 are electrically and optically connected via the universal cord 20T.

The signal-processing apparatus 70 is provided with a serial/parallel converter 74, a 10B/8B converter 80, a clock 71, a controller 76, an image processor 75, memory 73, an output circuit 77, and a light source 72.

The scope tip portion 20E is provided with an objective lens 26, a CMOS 28 (an imaging sensor), an A/D converter 30, a timing generator 32, an 8B/10B converter 40, a parallel/serial converter 34, and a diffusion lens 22.

Illumination light L is emitted from the light source 72 and is transmitted to the scope tip portion 20E through a light-guide fiber 24 provided inside the scope 20, and in turn spread by the diffusion lens 22. The illumination light L from the scope tip portion 20E illuminates an object (not shown) and the illumination light L reflected from the object surface is incident on the scope tip portion 20E. The reflected illumination light that is made incident on the scope tip portion 20E forms an image of the object on CMOS 28 through the objective lens 26.

The CMOS 28 generates video signals in accordance with the horizontal synchronization signals and clock pulses CLK from the timing generator 32 (discussed later), and feeds analog video signals to the A/D converter 30. Here, the vertical synchronization signal Vs signals when to start capturing an image, and each pulse of the clock pulse CLK corresponds to each pixel in the CMOS 28. Namely, pixel data of each pixel composing a picture imaged by the CMOS 28 is output sequentially in step with the clock pulse CLK, when the horizontal synchronization signal Vs and the clock pulse CLK are supplied to the CMOS 28.

The A/D converter 30 digitizes the analog video signal to 8-bit digital data in accordance in step with the clock pulses CLK from the timing generator 32 and outputs them to the 8B/10B converter 40 as parallel data, i.e., digital video signal D8. Namely, a digital video signal generator is provided by the CMOS 28 and the A/D converter 30.

As discussed later, the 8B/10B converter 40 composites information related to a synchronization indication signal and the synchronization signals with the digital video signals D8 in sync with the vertical synchronization signal Vs and the horizontal synchronization signal Hs coming from the timing generator 32, and the clock pulse CLK from the clock 71, respectively. The composite (compound) signals are encoded into 10-bit, parallel digital video data signals (composite code-signals D10) and are then fed to the parallel/serial converter 34. Here, the horizontal synchronization signal Hs is a signal indicating the timing to start scanning one horizontal line in the CMOS 28.

The parallel/serial converter 34 converts the composite code-signal D10 into serial data according to the clock pulse CLK from the clock 71. Furthermore, the serial data is transmitted to the serial/parallel converter 74 in the signal-processing apparatus 70 via a channel 20L provided inside the universal cord 20T. Namely, in the present embodiment, the scope tip portion 20E functions as a digital video signal transmitter. Note that the parallel/serial converter 34 includes a frequency multiplier circuit which multiplies the frequency of the clock pulse CLK by ten, and 10-bit serial data is incorporated into one period of the multiplied clock pulse CLK. Thus, the data transmission rate of the 10-bit composite code-signal before and after the parallel/serial conversion is maintained the same.

The timing generator 32 (a synchronization signal generator) generates the vertical synchronization signal Vs and the horizontal synchronization signal Hs according to a control signal from the controller 76 and the clock pulses CLK from the clock 71. Furthermore, the timing generator 32 supplies the vertical synchronization signal Vs to the CMOS 28 and 8B/10B converter 40, the horizontal synchronization signal Hs to the 8B/10B converter 40, and the clock pulse CLK to the CMOS 28 and the A/D converter 30.

The serial/parallel converter 74 transforms 10-bit serial data, which is input via the transmission line 20L, into 10-bit parallel data (the composite code-signal D10) with reference to the clock pulses CLK from the clock 71. The composite code-signal D10 is then fed to the 10B/8B converter 80.

As will be described later, the 10B/8B converter 80 decodes the composite code-signal D10 with reference to the clock pulses CLK from the clock 71. Namely, the compound video signal Dv (in which the synchronization-indication signal and the digital video signal D8 is composited), the horizontal synchronization signal Vsync′, and the vertical synchronization signal Hsync′ are generated and are fed to the image processor 75.

Image processor 75 deletes the synchronization-indication signal from the compound video signal Dv to extract the digital video signal D8 and stores the digital video signal D8 in memory 73. The digital video signals D8 stored in memory 73 are further subjected to image processing including a white-balance process and a gamma correction process in the image processor 75, and then fed to the output circuit 77.

The output circuit 77 converts the input digital video signals D8 into analog signals of a certain type of video format and then outputs them to a monitor (not shown) connected to the signal-processing apparatus 70.

As described above, in the present embodiment, the signal-processing apparatus 70 functions as a digital video signal receiver.

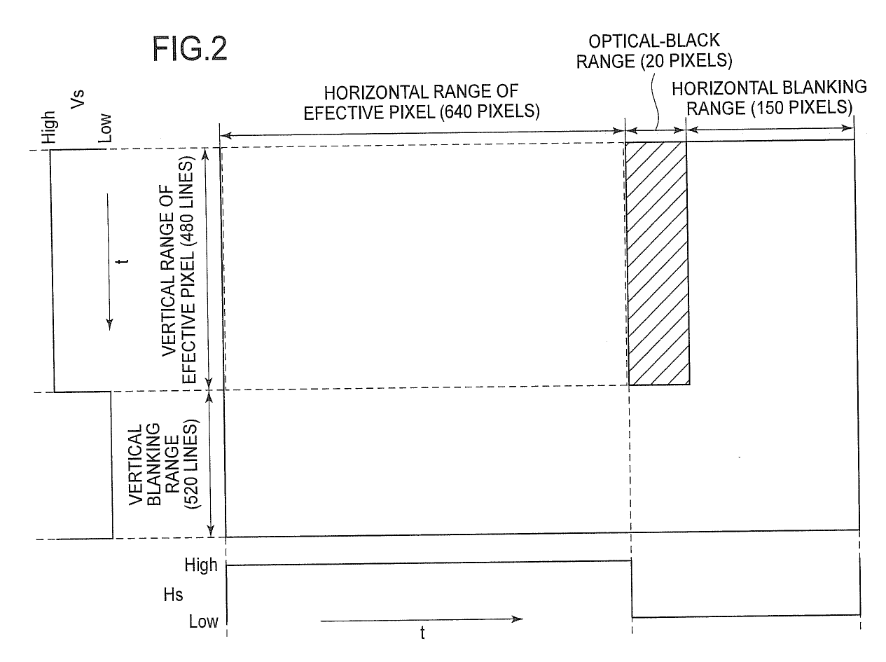

FIG. 2 illustrates the relationship between the pixels arranged on the CMOS 28 of the present embodiment, the clock pulse CLK, the vertical synchronization signal Vs, and the horizontal synchronization signal Hs. The area enclosed by the dashed line in FIG. 2 corresponds to pixel data of the effective pixel area of the CMOS 28 and the rectangular area surrounded by the outermost solid line corresponds to pixel data of the entire image of the CMOS 28.

The imaging surface of the CMOS 28 is composed of a plurality of two-dimensionally arranged pixels. For example, one horizontal line (one scanning segment) may be comprised of 640 effective pixels (the horizontal extent of the effective pixel field) and a succeeding 20 optical-black pixels aligned horizontally from the left edge of the imaging surface to the right. Furthermore, a vertical line may be comprised of 480 effective pixels (the vertical extent of the effective pixels) aligned vertically from the top edge of the imaging surface. Therefore, the pixels within the area defined by the horizontal and vertical ranges (the rectangular area surrounded by a dash line in FIG. 2) constitute the pixels which are effective in capturing an object image. On the other hand, pixels in the optical-black range (the hatched area) are provided with a light shield and used to generate the standard black signal.

Each of the pixel values from the upper left pixel of the imaging surface to the right side are sequentially output from the CMOS 28 according to the clock pulses CLK when a rising edge (a transition from a low to high level) of the vertical synchronization signal Vs is detected by the CMOS 28. When the pixel data of the horizontal range of the effective pixels and the optical-black range in the first horizontal line are output, clock pulses CLK that correspond to 150 pixels are counted as a horizontal blanking period, and subsequently pixel data output from the first horizontal line ends. Namely, the pixel data output for one horizontal line ends with 810 counts of clock pulse CLK. Furthermore, the output of the second horizontal line starts with the 811^{th} pulse, and the pixel data of the second horizontal line are output as in the first horizontal line. Just as with the first and second horizontal lines, the pixel data of the third and succeeding horizontal line are next output in turn.

From the 481^{st} horizontal line to 1000^{th} horizontal line corresponds to a vertical blanking period, and when this period elapses, pixel data output of one image (a field or frame of image) concludes. Namely, in this embodiment, the pixel data of one image is comprised of 1000 horizontal lines of pixel data.

The horizontal synchronization signal Hs is generated by the timing generator 32 and used to distinguish the horizontal range of effective pixels and the optical-black range from the horizontal blanking range in each horizontal line of the CMOS 28, and represents the beginning of each horizontal line. More specifically, the horizontal synchronization signal Hs is set to a high level during the pixel data of the horizontal range of the effective pixel, i.e., 640 pixels, are output, and is switched to a low level when the pixel data output of the effective pixels in one horizontal line ends. Furthermore, the horizontal synchronization signal Hs is set to the low level during the pixel data of the horizontal blanking range are output, and in turn, switched from the low level to the high level at the beginning of the pixel data output for the next horizontal line.

The vertical synchronization signal Vs is generated by the timing generator 32 and used to distinguish the vertical range of effective pixels from the vertical blanking range of the CMOS 28, and represents the beginning of each image (a field or frame image). More specifically, the vertical synchronization signal Vs is set to a high level while the pixel data of the vertical range of the effective pixels, i.e., 480 lines, is output, and is switched to a low level when the pixel data output of the effective pixels ends. Furthermore, the vertical synchronization signal Vs is set to the low level while the pixel data of the vertical blanking range is output, and in turn, switched from the low level to the high level at the beginning of the pixel data output for the next image (field or frame image).

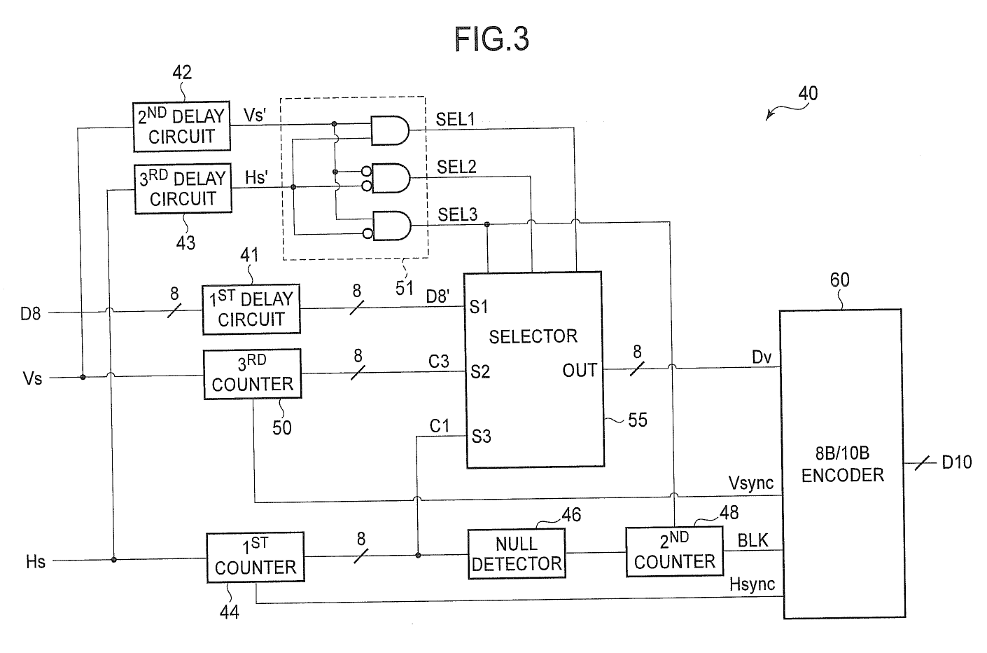

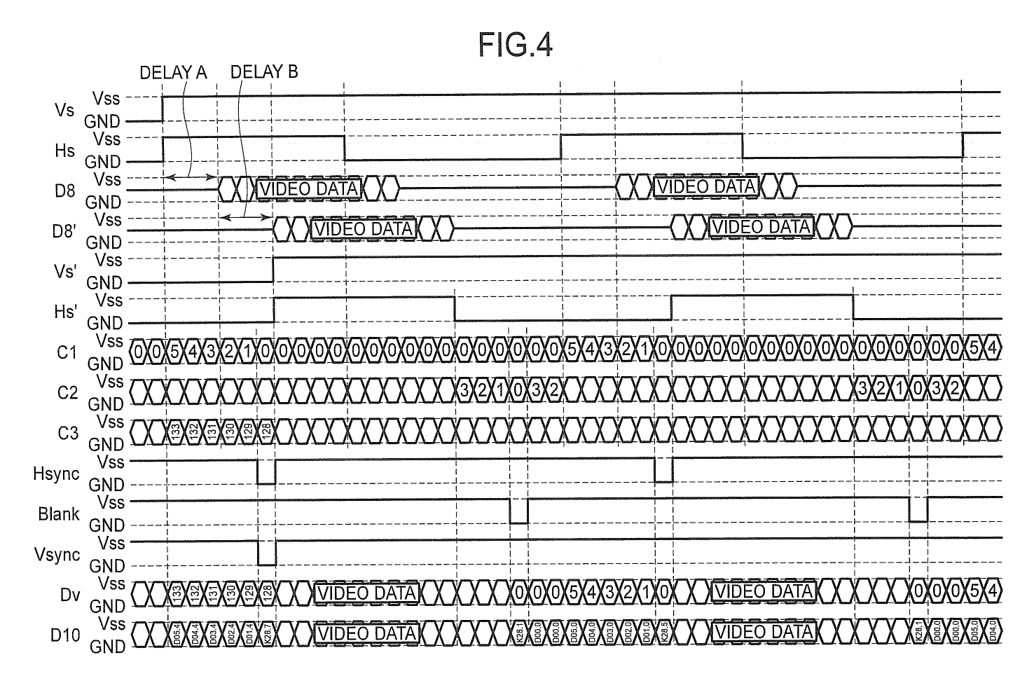

FIG. 3 is a block diagram showing structures of the 8B/10B converter 40 of the present embodiment, and FIG. 4 is a timing chart to illustrate the function of each block described in FIG. 3. In FIG. 4, parallel signals are represented by a series of hexagonal patterns. Units of parallel data are indicated by the hexagonal regions. Incidentally, in FIGS. 3 and 4, the same references are used to indicate corresponding signals.

The 8B/10B converter 40 includes a first delay circuit 41, a second delay circuit 42, a third delay circuit 43, a first counter 44, a second counter 48, a third counter 50, a null detector 46, a gate circuit 51, a selector 55, and an 8B/10B encoder 60.

A digital video signal D8 from the A/D converter 30 is delayed for a time period corresponding to a predetermined number of pixels through the first delay circuit 41, and in turn, the delayed digital video signal D8′ is supplied to a terminal S1 of the selector 55. In the present embodiment, the digital video signal D8 is delayed at the A/D converter 30 for a period (delay A) corresponding to three pixels, and further delayed by the first delay circuit 41 for a period (delay B) corresponding to three pixels. Thus, in the present embodiment, the digital video signal D8′ is delayed from the vertical synchronization signal Vs and the horizontal synchronization signal Hs for a time period corresponding to six pixels.

The vertical synchronization signal Vs from the timing generator 32 is fed to the second counter 42 and the third counter 50. The third counter is a count-down counter with a settable starting value. In the present embodiment, the third counter 50 starts to count down from 133 to 128, with in step with the clock pulse CLK, when a rising edge of the vertical synchronization signal Vs is detected. Furthermore, the count number C3 of the third counter 50 is fed to a terminal S2 of the selector 55. When the count number C3 reaches 128, the third counter 50 outputs a vertical synchronization pulse Vsync to the 8B/10B encoder 60 and stops counting at the same time. Namely, the count number C3 takes a role of a synchronization-indication signal that indicates the time at which to output the vertical synchronization pulse Vsync.

The second delay circuit 42 delays the vertical synchronization signal Vs for a time period corresponding to a predetermined number of pixels, and in turn, the delayed vertical synchronization signal Vs′ is fed to the gate circuit 51. In the present embodiment, the vertical synchronization signal Vs′ is delayed for a time period corresponding to six pixels by the second delay circuit 42. Namely, the rising edge of the delayed vertical synchronization signal Vs′ coincides with the start of the output of the delayed digital video signal D8′.

The horizontal synchronization signal Hs from the timing generator 32 is fed to the first counter 44 and the third delay circuit 43. The first counter is a counter of a type that counts down from a predetermined number. In the present embodiment, the first counter 44 starts to count down from 5 to 0, in step with the clock pulse CLK, when a rising edge of the horizontal synchronization signal Hs is detected. Furthermore, the count number C1 of the first counter 44 is fed to a terminal S3 of the selector 55. When the count number C1 reaches 0, the first counter 44 outputs a horizontal synchronization pulse Hsync to the 8B/10B encoder 60 and stops counting at the same time. Namely, the count number C1 takes on the role of a synchronization-indication signal that indicates the instant at which to output the horizontal synchronization pulse Hsync.

The null detector 46 is a device that determines whether the count number C1 has reached 0, and the output of the null detector 46 is input to the second counter 48. The second counter 48 is a countdown timer that cycles from a predetermined number. The countdown of the second counter 48 is triggered by a control signal SEL3 (described later) and the countdown from the predetermined number is repeated while the count number C1 is 0. In the present embodiment, the second counter 48 cyclically counts down from 3 to 0 while the count number C1 is 0, and outputs the blanking pulse BLK to the 8B/10B encoder 60 when the count number C1 is 0. Furthermore, the second counter 48 stops counting when the count number C1 is not 0.

The third delay circuit 43 delays the horizontal synchronization signal Hs for a time period corresponding to a predetermined number of pixels and the delayed horizontal synchronization signal Hs′ is fed to the gate circuit 51. In the present embodiment, a delay of six pixels' duration is enforced by the third delay circuit 43. Namely, the rising edge of the delayed vertical synchronization signal Hs′ coincides with the start of the delayed digital video signal D8′ output.

The gate circuit 51 is a two-input three-output logic circuit that outputs a switching signal to the selector 5 in accordance with the delayed vertical synchronization signal Vs′ and the delayed horizontal synchronization signal Hs′, which it (gate circuit 51) receives. More specifically, when both the vertical synchronization signal Vs′ and the horizontal synchronization signal Hs′ are High, it supplies a control signal SELL to the selector 55 to select a signal input from the terminal S1. When both the vertical synchronization signal Vs′ and the horizontal synchronization signal Hs′ are Low, it supplies a control signal SEL2 to the selector 55 to select a signal input from the terminal S2. Furthermore, when the vertical synchronization signal Vs′ is High and the horizontal synchronization signal Hs′ is Low, it supplies a control signal SEL3 to the selector 55 to select a signal input from the terminal S3.

The selector 55 selects a signal to be output to the 8B/10B encoder 60 from the signals input through the terminal S1, terminal S2, and terminal S3, in accordance with a control signal from the gate circuit 51. Namely, when both the vertical synchronization signal Vs′ and the horizontal synchronization signal Hs′ are High, the selector 55 outputs the digital video signal D8′ to the 8B/10B encoder 60, and when both the vertical synchronization signal Vs′ and the horizontal synchronization signal Hs′ are Low the selector 55 outputs the count number C3 to the 8B/10B encoder 60. Furthermore, when the vertical synchronization signal Vs′ is High and the horizontal synchronization signal Hs′ is Low, the selector 55 outputs the count number C1 to the 8B/10B encoder 60. Thus, the output signal of the selector 55, i.e., a compound video signal Dv (see FIG. 4), is a composition of the digital video signal D8′, the synchronization-indication signal (count number C3) which indicates the vertical synchronization pulse Vsync, and the synchronization-indication (count number C1) which indicates the horizontal synchronization pulse Hsync.

As described above, in the present embodiment, the numbers from 133 to 128, i.e., from “1000 0101” to “1000 000” in binary, are assigned to the synchronization-indication signal of the vertical synchronization pulse Vsync, and the numbers from 5 to 0, i.e., from “0000 0101” to “0000 0000”, are assigned to the synchronization-indication signal of the horizontal synchronization pulse Hsync. Therefore, the synchronization-indication signals of the vertical synchronization pulse Vsync and the horizontal synchronization pulse Hsync that are incorporated in the compound video signal Dv can be identified by the most significant bit (msb). Namely, the most significant bit of the synchronization-indication signal indicates whether the synchronization-indication signal represents a vertical or horizontal synchronization pulse, and the subordinate 7 bits represent the value of the signal which the synchronization-indication signal reports on.

The 8B/10B encoder 60 encodes the compound video signal Dv, the vertical synchronization pulse Vsync, the horizontal synchronization pulse, and the blanking pulse BLK into 8B/10B code and outputs the encoded signal to the parallel/serial converter 34 (see FIG. 1) as a composite code signal D10.

The 8B/10B code is one of the so-called DC-free code, in which the frequencies of High signals and Low signals are set to be approximately equal in frequency of occurrence, and in particular, transmitted by serial data communication to improve noise-tolerance (for example, refer to WO/2002/091586). Furthermore, when transmitting 8B/10B codes, a special character code (the comma) within 8B/10B code is used to synchronize the transmitter and the receiver (here, for example, refer to U.S. Pat. No. 5,347,547).

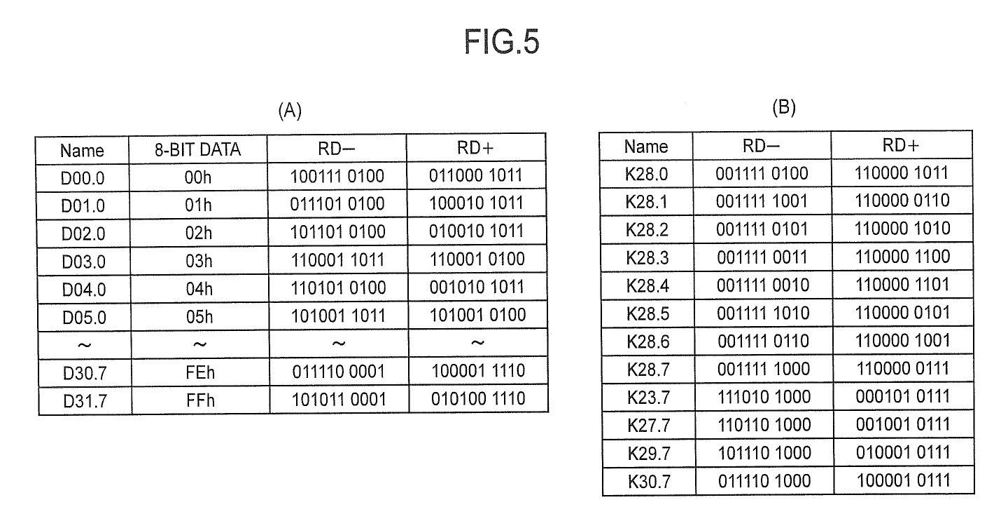

FIG. 5 is an example of the encoding tables adopted in the 8B/10B converter 40. FIG. 5(A) is an example of a data table for encoding the compound video signal Dv into 10-bit data. FIG. 5(B), on the other hand, is an example of special code for encoding the vertical synchronization pulse Vsync, the horizontal synchronization pulse Hsync, and the blanking pulse BLK, etc., into 10-bit data.

The title “Name” in the data table denotes the name of the data and “8-bit data” denotes the compound video signal Dv. In addition, “RD−” indicates an encoded first datum of 10 bits, and “RD+” indicates an encoded second datum of 10 bits. In the column “8-bit data”, 256 values from 00h to FFh (hexadecimal) are indicated, and assigned a corresponding first and second datum. Here, the first data are 10-bit values where the number of 1s and 0s are equal in number or where the number of 1s exceeds the number of 0s by at most one, and which are defined to have a one-to-one correspondence with the aforementioned 255 data types. The second data are also 10 bit-data, but where the number of 1s and 0s are equal or the number of 0s exceeds the number of 1s by at most one, and which is also defined to have one-to-one correspondence with the 255 data types. Either the first or the second data are is selected and output to form a DC-free code in which the total number of 1s and the total number of 0s are substantially equal

The title “Name” in the special code table denotes the name of the special code, “RD−” indicating an encoded first data of 10 bits, while “RD+” indicates an encoded second data, also of 10 bits. Each of the first and second data are assigned to a corresponding special code.

In addition to the data table, the first data are 10-bit data where the number of 1s and 0s are equal or the number of 1s exceeds the number of 0s by at most one, and which is defined to have a one-to-one correspondence with the special codes. The second data is 10-bit data where the number of 1s and 0s are equal or the number of 0s exceeds the number of 1s by at most one, and which is defined as to have a one-to-one correspondence with the special codes. The first data and the second data are selected so as to be represented in DC-free code where the total number of 1s and 0s are substantially equal, and one of the first or second data is output. In the present embodiment, a special code, K28.7, is assigned to the vertical synchronization pulse Vsync, and a special code, K28.5, is assigned to the horizontal synchronization pulse Hsync, and a special code, K28.1, is assigned to the blanking pulse BLK. Note that the above assignment of the special codes is only an example and any other special code can be assigned to each pulse.

The 8B/10B encoder 60 encodes the compound video signal Dv in accordance with the data table. Furthermore, when the vertical synchronization pulse Vsync, the horizontal synchronization pulse Hsync, or the blanking pulse BLK is input, the 8B/10B encoder 60 encodes them according to the special code table. More specifically, when a compound video signal Dv is input to the 8B/10B encoder 60, the value of the compound video signal Dv is searched in the “8-bit data” of the data table, and the corresponding first data or second data is output alternatively. Furthermore, when the vertical synchronization pulse Vsync, the horizontal synchronization pulse Hsync, or the blanking pulse BLK is input, the first or second data corresponding to the respective K28.7, K28.5, and K28.1 code is searched and an alternative one is output prior to the compound video signal Dv. Namely, the encoded data of the compound video signal Dv is composited with the vertical synchronization pulse Vsync, the horizontal synchronization pulse Hsync, and the blanking pulse BLK, as a series of encoded data, which is referred to as the composite code signal D10 (see FIG. 4). Thereby, the 8B/10B encoder 60 outputs the composite code signal D10 to the parallel/serial converter 34.

Referring to FIG. 1, the parallel/serial converter 34 converts the composite code signal D10 to serial data, and in turn, transmits the composite code signal D10 to the serial/parallel converter 74 of the signal-processing apparatus 70 through the channel 20L. The serial/parallel converter 74 converts the serial data, (which is received via the channel 20L), to the parallel composite code signal D10, and then supplies it to the 10B/8B converter 80.

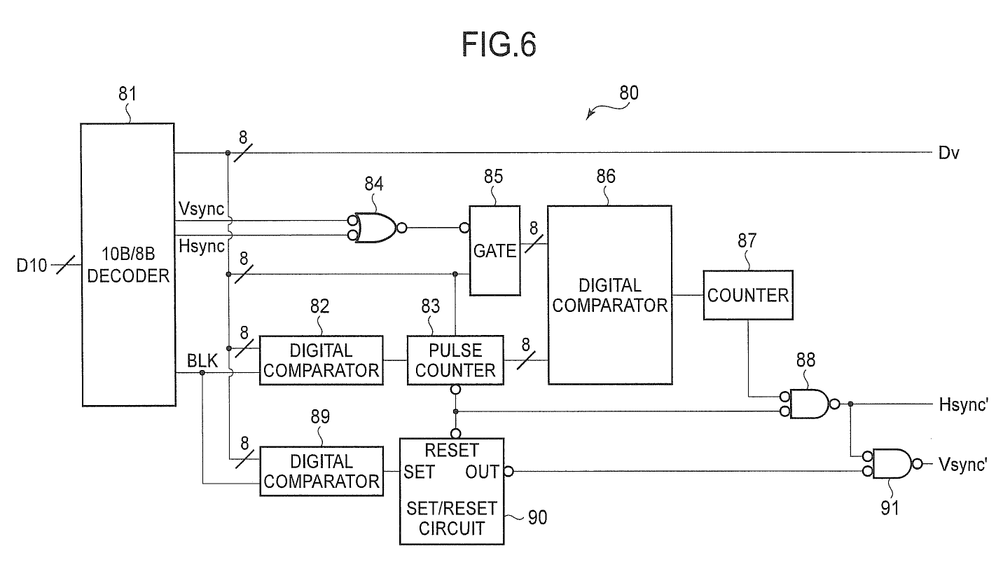

FIG. 6 is a block diagram of the 10B/8B converter 80 of the present embodiment.

The 10B/8B converter 80 includes a 10B/8B decoder 81, a digital comparator 82, a pulse counter 83, gate circuits 84 and 85, a digital comparator 86, a counter 87, a gate circuit 88, a digital comparator 89, a set/reset circuit 90, and a gate circuit 91.

The 10B/8B decoder 81 decodes 10-bit data of the input 8B/10B code (the composite code signal D10), and in turn, outputs the compound video signal Dv, the vertical synchronization pulse Vsync, the horizontal synchronization pulse Hsync, and the blanking pulse BLK. Specifically, the 10B/8B decoder 81 has the data table and the special code table indicated in FIG. 5, and as to the input first data or the second data, a corresponding “8-bit datum” or “special code” is obtained. When it is “8-bit data”, the corresponding 8-bit datum is output as the compound video signal Dv. When it is “special code” the corresponding vertical synchronization pulse Vsync, horizontal synchronization pulse Hsync, or the blanking pulse BLK is output.

The compound video signal Dv and the blanking pulse BLK from the 10B/8B decoder 81 is fed to the digital comparator 82. The digital comparator 82 then determines whether the signal value of the synchronization-indication signal (a number denoted by the subordinate 7 bits of the synchronization-indication signal, (which excludes the most significant bit); see FIG. 4), which is incorporated in the compound video signal Dv, is within the range of 1 to 5. When the signal value of the synchronization-indication signal is within the range of 1 to 5, the signal is output to the pulse counter 83 and the counting function of the pulse counter 83 is deployed. Namely, the digital comparator 82 functions as a detector that detects the synchronization-indication signal incorporated in the compound video signal Dv.

The pulse counter 83 counts down in step with the clock pulse CLK input, (see FIG. 1). When the pulse counter 83 receives a signal from the digital comparator 82, the signal value of the synchronization-indication signal incorporated in the compound video signal Dv (see FIG. 4), which is denoted by the subordinate 7 bits of the synchronization-indication signal is read and the countdown starts. For example, when the digital comparator 82 detects 4 as the signal value of the synchronization-indication signal, the count number of the pulse counter 83 is set to 4, and the count number is counted down in step with the clock pulse CLK input, i.e., 3, 2, 1, 0. Furthermore, the pulse counter 83 outputs the count number to the digital comparator 86, and when the count number is 0, it also outputs a pulse signal (a synchronization signal) to the gate circuit 88 and the set/reset circuit 90. Namely, the pulse counter 83 also functions as a synchronization signal generator as well as predicting the succeeding synchronization-indication signal from the first synchronization-indication signal detected by the digital comparator 82 (as a synchronization-indication prediction signal generator).

The gate circuit 84 is a circuit for detecting a vertical synchronization pulse Vsync and a horizontal synchronization pulse Hsync. The gate circuit 84 supplies a Low signal to the gate circuit 85 when either the vertical synchronization pulse Vsync or the horizontal synchronization pulse Hsync is detected.

The gate circuit 85 may be comprised of a switch circuit that switches the output based on a signal from the gate circuit 84. Specifically, when a signal from the gate circuit 84 is Low (i.e., when the vertical synchronization pulse Vsync or the horizontal synchronization pulse Hsync are input), 8-bit data “0000 0000” (00h) is output from the gate circuit 85 to the digital comparator 86. On the other hand, when the signal from the gate circuit 84 is High (i.e., when the vertical synchronization pulse Vsync and the horizontal synchronization pulse Hsync is not input), the signal value of the synchronization-indication signal incorporated in the compound video signal Dv (see FIG. 4), which is denoted by the subordinate 7 bits of the synchronization-indication signal, (excluding the most significant bit), is output from the gate circuit 85 to the digital comparator 86. Namely, when the vertical synchronization pulse Vsync and the horizontal synchronization pulse Hsync is not input, the output of the gate circuit 85 is equal to the signal value of the synchronization-indication signal, and when the vertical synchronization pulse Vsync or the horizontal synchronization pulse Hsync is input, the output of the gate circuit 85 is equal to the count number (00h) of the pulse counter 83.

The digital comparator 86 compares the output of the gate circuit 85 (the signal value of the synchronization-indication signal or 00h) and the count number of the pulse counter 83 (synchronization-indication prediction signal). When the output of the gate circuit 86 and the count number of the pulse counter 83 coincide, a pulse signal is output from the digital comparator 86 to the counter 87. The counter 87 is a countdown timer which starts with an initial value of 2 and starts counting down when the pulse signal from the digital comparator 86 is input. Furthermore, when the count number reaches 0, the counter 87 outputs a Low signal to the gate circuit 88. More specifically, digital comparator 86 compares the synchronization-indication prediction signal and the signal value of the synchronization-indication signal incorporated in the compound video signal Dv. When the two coincide, it decrements the count number of counter 87, therefore, counter 87 functions as a coincidence counter that counts the number of coincidences between the two. Note that when the vertical synchronization pulse Vsync or the horizontal synchronization pulse Hsync is input, the gate circuit 85 outputs “00h”, which coincides with the count number (the synchronization-indication prediction signal) of the pulse counter 83, so that the count number of the counter 87 is incremented by one.

The output of the counter 87 and the pulse counter 83 are input to the gate circuit 88. The gate circuit 88 sends the output from the pulse counter 83 when the output of the counter 87 is Low. Namely, when the synchronization-indication prediction signal and the synchronization-indication signal coincide two or more times, the output of the pulse counter 83 is enabled and the horizontal synchronization signal Hsync′ is output from the gate circuit 88.

In the present embodiment, six types of synchronization-indication signals, having values from 0 to 5, are composited with the compound video signal Dv (see FIG. 4). Therefore, for example, even when signal values other than 5 or 3, i.e., values of 4, 2, 1, or 0, are garbled in channel 20L, the horizontal synchronization signal Hsync′ can be output at a proper timing if two synchronization-indication signals 5 and 3 are properly received. Furthermore, in the present embodiment, since the count number of counter 87 is incremented by one when either of the vertical synchronization pulse Vsync or the horizontal synchronization pulse Hsync is input, at least one of the values of the synchronization-indication signal must coincide with the synchronization-indication prediction signal, and thus the horizontal synchronization pulse Hsync′ is output when either the vertical synchronization pulse Vsync or the horizontal synchronization pulse Hsync is input. For example, even when signal values other than 4, i.e., the signal values 5, 3, 2, 1, and 0, are garbled in channel 20L, one of the synchronization-indication signals (synchronization indication signal of value 4) should be received properly. Thus, if either the vertical synchronization pulse Vsync or the horizontal synchronization pulse Hsync is received properly, the horizontal synchronization signal Hsync′ is properly output. Note that in the description of the present embodiment, the initial value of the counter 87 is set to 2, (this being only an example), and the initial value may be increased according to the number of the synchronization-indication signals. The reliability of synchronization signal detection is improved by increasing the initial value of the counter 87.

The compound video signal Dv from the 10B/8B decoder 81 and the blanking pulse BLK are input to the digital comparator 89. When the blanking pulse BLK is input to the digital comparator 89, the digital comparator 89 begins the identification of the synchronization indication signal incorporated in the compound video signal Dv, or, in other words, determining whether the most significant bit of the synchronization-indication signal is 1. When it is determined that the identification signal is 1, a High signal is output from the digital comparator 89 to the set/reset circuit 90 so that the circuit 90 will output a Low signal. Here, the set/reset circuit 90 is a device that outputs a Low signal (a set signal) when the SET terminal input is High, and outputs a High signal (a reset signal) when the RESET terminal input is Low. The output signal of the set/reset circuit 90 is fed to the gate circuit 91.

In the present embodiment, the situation in which the most significant bit is set to 1 occurs when the synchronization-indication signal of the vertical synchronization pulse Vsync has a value within the range of 128 to 133, i.e., “1000 0000” to “1000 0101” in binary, and therefore, the digital comparator 89 functions as an indication signal detector that detects the synchronization indication signal of the vertical synchronization pulse Vsync. Furthermore, when the synchronization-indication signal is in the range of 128 to 133, the digital comparator 82 detects the subordinate 7 bits of the synchronization-indication signal, excluding the most significant bit of the 8-bit data, where the values are represented by “*000 0000” to “*000 0101”. Therefore, the digital comparator 82 detects the value of the synchronization-indication signal as a value within 0 to 5 when the value of the synchronization-indication signal is within 128 to 133, and as described above, the gate circuit 88 outputs the horizontal synchronization signal Hsync′ when the values of the synchronization-indication prediction signal and the synchronization-indication signal coincide at least two times.

The output of the set/reset circuit 90 and the output of the gate circuit 88 are input to the gate circuit 91, and the gate circuit 91 outputs the vertical synchronization signal Vsync′ when the signals from the both set/reset circuit 90 and gate circuit 88 are Low. Namely, the vertical synchronization signal Vsync′ is output with the horizontal synchronization signal Hsync′ when the synchronization indication signal incorporated in the compound video signal Dv is in the range of 128 to 133 and when the synchronization indication prediction signal and the synchronization indication signal coincide at least twice.

As described above, the composite code signal D10 from the scope tip portion 20E is transmitted to the processor apparatus 70 via the channel 20L, and thus the compound video signal Dv is obtained by the processor apparatus 70, and further, the horizontal synchronization signal Hsync′ and the vertical synchronization signal Vsync′ are reproduced in the processor apparatus 70. Furthermore, since the horizontal synchronization signal Hsync′ and the vertical synchronization signal Vsync′ are reproduced in accordance with the synchronization-indication signal, the vertical synchronization pulse Vsync, the horizontal synchronization pulse Hsync, and the blanking pulse BLK, which are incorporated into the composite code signal D10, and the synchronization signals are properly generated from the synchronization-indication signal of the composite code signal D10, even when the synchronization signals in the composite code signal D10 are garbled in the channel 20L, and thus, appropriate images can be reproduced on the receiving side.

In the present embodiment, signals transmitted from the scope tip portion 20E to the processor apparatus 70 are encoded to 8B/10B code and transmitted as a serial composite code signal D10, but this is just an example, and not a limitation. For example, only a parallel compound video signal Dv including the synchronization-indication signal can be transmitted between the two. This is because the vertical synchronization signal Vsync′ as well as the horizontal synchronizing signal Hsync′ are properly reproduced from the synchronization-indication signal as described above. In this example, a plurality of signal lines are required for channel 20L, however, the 8B/10B encoder 60, the 10B/8B decoder 80, the parallel/serial converter 34, and the serial/parallel converter 74 can all be omitted.

Despite the fact that in the embodiment described above, the invention is applied to a transmitter and a receiver used to transmit digital video signals in an electronic endoscope system, it is also applicable to any type of digital video signal transmission system, including a DVD player, a TV monitor, or the like.

Furthermore, the structures described in the present embodiment are only an example and are not limited to only those examples. By way of another example, the 8B/10B converter 40 and the 10B/8B converter 80 may be replaced by a microcomputer or something similar. Furthermore, although in this description the 8B/10B code is used as an example of a DC-free code, any other DC-free code may also be applied.

In the present embodiment, although the 8-bit digital video signal D8 is delayed for a period corresponding to six pixels with respect to the synchronization signal to composite the synchronization-indication signal, this is only an example. By way of another example, the delay time may be elongated to enable more synchronization-indication signals to be composited to the compound video signal. The reliability of a synchronization-signal-detecting operation at the receiver can be improved by increasing the synchronization-indication signals to be composited with the compound video signal.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2008-121887 (filed on May 8, 2008) which is expressly incorporated herein, by reference, in its entirety.

1. A digital video signal transmitter comprising:
a digital video supplier that supplies a digital video signal including effective pixel signals comprised of pixel data from an effective pixel area and blanking signals comprised of data from a blanking area;
a synchronization signal generator that outputs a synchronization signal which is synchronized with the digital video signal; and
a signal generator that generates a compound video signal in which a plurality of synchronization-indication signals that indicate the timing of the synchronization signal, is incorporated into the blanking signals in step with the digital video signal and the synchronization signal.

2. A digital video signal transmitter according to claim 1, wherein each of the synchronization-indication signals corresponds to respective pixels from a leading pixel that is at least two pixels prior in transmission to said effective pixel area, until the final pixel of said blanking area, and all pixel data corresponding to the synchronization-indication signals comprises data representing the positional relationship between each of said respective pixels and said final pixel.

3. A digital video signal transmitter according to claim 2, wherein said pixel data corresponding to the synchronization-indication signals decreases from said leading pixel to said final pixel, in order.

4. A digital video signal transmitter according to claim 2, wherein pixel data corresponding to the synchronization signal is binary data comprised of a plurality of bits, and a synchronization-indication signal corresponding to said final pixel is binary data in which the least significant bit is 0.

5. A digital video signal transmitter according to claim 1, further comprising a delay circuit that delays the digital video signal with respect to the synchronization signal, by a period corresponding to the transmission period of a predetermined number of pixels, and said signal generator incorporates the synchronization-indication signals into said predetermined pixels.

6. A digital video transmitter according to claim 1, wherein the synchronization signal includes a horizontal synchronization signal and a vertical synchronization signal, and wherein a synchronization-indication signal for the horizontal synchronization signal and a synchronization indication signal for the vertical synchronization signal are separate signals.

7. A digital video transmitter according to claim 1, further comprising an encoder that generates a composite code signal by encoding the compound video signal into DC-free code; and
a serializer that serializes the composite code signal and transmits a serialized composite code signal.

8. A digital video signal transmitter according to claim 7, wherein the signal generator further generates a synchronization pulse in accordance with the synchronization signal and generates a blanking pulse within the transmission period of the blanking signals; and
wherein the encoder further encodes the synchronization pulse and the blanking pulse into the DC-free code and composites it with the composite code signal.

9. A digital video signal transmitter, wherein the DC-free code comprises an 8B/10B code.

10. A digital video signal receiver for receiving a digital video signal that includes effective pixel signals comprised of pixel data from an effective pixel area and blanking signals comprised of data from a blanking area, said digital video signal receiver comprising:
a receiver that receives a compound video signal in which a plurality of synchronization-indication signals indicating the timing of a synchronization signal is incorporated into the blanking signals with reference to the digital video signal and the synchronization signal;
an indication-signal detector that detects the synchronization-indication signal in the compound video signal;
a synchronization-indication prediction signal generator that generates a synchronization-indication prediction signal by predicting a succeeding synchronization-indication signal from a first synchronization-indication signal detected by said indication-signal detector;
a synchronization signal generator that reproduces the synchronization signal in accordance with the synchronization-indication prediction signal; and
a coincidence counter that counts the number of coincidences between the synchronization-indication prediction signal and the synchronization-indication signal;
the synchronization signal being output from said synchronizing generator when the number of coincidences is two or more.

11. A digital video signal receiver according to claim 10, wherein the compound video signal is encoded into a serial composite code signal expressed in DC-free code,
wherein said digital video signal receiver further comprises:
a serial/parallel converter that receives the serial composite code signal and converts serial data of the serial composite code signal into parallel data; and
a decoder that reproduces the compound video signal by decoding the parallel data of the composite code signal received by said serial/parallel converter.

12. A digital video transmission system, comprising:
a digital video signal transmitter comprising:
a digital video supplier that supplies a digital video signal including effective pixels signals comprised of pixel data from an effective pixels area and blanking signals comprised of data from a blanking area;
a first synchronization signal generator that outputs a synchronization signal which is synchronized with the digital video signal;
a signal generator that generates a compound video signal in which a plurality of synchronization-indication signals that indicate timing of the synchronization signal is incorporated into the blanking signals with reference to the digital video signal and the synchronization signal; and
a digital video signal receiver, comprising:
an indication signal detector that detects the synchronization-indication signal in the compound video signal;
a synchronization-indication prediction signal generator that generates a synchronization-indication prediction signal by predicting a succeeding synchronization-indication signal from a first synchronization-indication signal detected by said indication signal detector;
a second synchronization signal generator that reproduces the synchronization signal in accordance with the synchronization-indication prediction signal; and
a coincidence counter that counts the number of coincidences between the synchronization-indication prediction signal and the synchronization-indication signal;
the synchronization signal being output from said second synchronizing generator when the number of coincidences is two or more than two.

13. A digital video transmission system according to claim 12, wherein said digital video transmitter further comprises an encoder that generates a composite code signal by encoding the compound video signal into DC-free code, and a serializer that serializes the composite code signal and transmits a serialized composite code signal;
wherein said digital video signal receiver further comprises a serial/parallel converter that receives the serialized composite code signal and converts serial data into parallel data, and a decoder that reproduces the compound video signal by decoding the serialized composite code signal received by said serial/parallel converter.

14. A method for transmitting a digital video signal, comprising:
outputting a digital video signal including effective pixels signals comprised of pixel data from an effective pixel area and blanking signals comprised of data from a blanking area;
outputting a synchronization signal which is synchronized with the digital video signal; and
generating a compound video signal in which a plurality of synchronization-indication signals that indicate the timing of the synchronization signal is incorporated into the blanking signals with reference to the digital video signal and the synchronization signal.
